(19) United States
(12) Patent Application Publication
(10) Pub. No.: US 2017/0326720 A1
(43) Pub. Date: Nov. 16, 2017

(54) POWER TOOL

(71) Applicant: MAKITA CORPORATION, ANJO-SHI (JP)

(72) Inventors: Takao KUROYANAGI, Anjo-shi (JP); Haruki TEJIMA, Anjo-shi (JP)

(21) Appl. No.: 15/490,063

(22) Filed: Apr. 18, 2017

(30) Foreign Application Priority Data
May 13, 2016 (JP) 2016-097332

(51) Int. Cl. B25F 5/02; B25B 21/02; B25B 23/18; H01M 2/10

(52) U.S. Cl. CPC B25F 5/021; H01M 2/1022; B25B 21/02; B25B 23/18; H01M 2220/30

(57) ABSTRACT

A power tool, such as an impact driver, includes a motor housing that houses a motor, and a battery-mount part to which a battery pack having a rated voltage of 18 V is mountable. A ratio of the maximum width of the motor housing to the maximum width of the battery pack is 0.75 or less. A forward/reverse-switching lever is slidable in a left-right direction to change the rotational direction of the motor and is disposed between the motor housing and the battery pack. A maximum-slide position of the forward/reverse-switching lever in the left-right direction is inward of a ground plane when the power tool is laid horizontally on its side on the ground plane.

### CROSS-REFERENCE

The present application claims priority to Japanese patent application serial number 2016-97332 filed on May 13, 2016, the contents of which are incorporated fully herein by reference.

### TECHNICAL FIELD

The present invention relates to a power tool in which a battery pack that serves as a power supply drives a motor.

### BACKGROUND ART

Cordless power tools are known in which a motor is driven using a battery pack, which is mounted on a housing, in order to drive an output part, such as a chuck, a bit holder, a saw blade, etc. Such cordless power tools utilize a motor that is driven with a battery pack, which has a prescribed rated voltage.

### SUMMARY

If the rated voltage of the battery pack is increased (e.g., to 18 V) in order to generate a greater power output, the size of the motor (i.e., the outer diameter of the stator) likewise increases commensurately, leading to an increase in the size of the housing that houses the motor. Consequently, handling of the power tool becomes adversely difficult in confined work locations.

Accordingly, it is one object of the present teachings to provide power tools that excel in ease of use and can be made compact even if a battery pack having a high rated voltage is used.

In a first aspect of the present teachings, a power tool comprises: a motor housing that houses a motor; and a battery-mount part to which a battery pack having a rated voltage of 18 V is mountable; wherein the maximum width of the motor housing and the maximum width of the battery pack have the following relationship:

(Maximum Width of Motor Housing)/(Maximum Width of Battery Pack)<0.75.

In a second aspect of the present teachings, a power tool comprises: a motor housing that houses a motor; and a battery-mount part to which a battery pack having a rated voltage of 18 V mountable; wherein the outer diameter of the motor is 40 mm or less.

In a third aspect of the present teachings, a power tool comprises: a motor housing that houses a motor; and a battery-mount part to which a battery pack having a rated voltage of 18 V is mountable; wherein the motor housing has a tube shape in which an axis line extends in a front-rear direction; and the distance from the axis line to a maximum-height position of the motor housing is 27 mm or less.

In a fourth aspect of the present teachings, the motor housing of any of the preceding aspects is formed by joining, using one or more screws, a pair of left and right housing halves together; and on an upper side of the motor, a bevel is formed on a lower surface of a screw boss for joining the housing halves together.

In a fifth aspect of the present teachings, a power tool comprises: a motor housing that houses a motor; and a battery-mount part to which a battery pack having a rated voltage of 18 V is mountable; wherein the motor has a rated voltage of 10.8 V.

In a sixth aspect of the present teachings, the power tool of any of the preceding aspects includes a forward/reverse-switching lever of the motor, which is capable of sliding in a left-right direction, provided between the motor housing and the battery pack; wherein a maximum-slide position of the forward/reverse-switching lever in the left-right direction is inward of the ground plane when the battery pack is placed horizontally on the ground plane.

In a seventh aspect of the present teachings, the power tool of any of the preceding aspects includes a switch panel, which comprises an operation part and a display, provided on an upper surface of the battery-mount part; wherein the motor housing is disposed upward of the switch panel and the left-right width of the switch panel is smaller than the left-right width of the motor housing.

In an eighth aspect of the present teachings, the display is disposed within the left-right width of the motor housing in a plan view.

In a ninth aspect of the present teachings, the outer diameter of the motor of any of the preceding aspects is 38 mm and the outer diameter of the motor housing of any of the preceding aspects is 46 mm.

In a tenth aspect of the present teachings, the battery-mount part of any of the preceding aspects is provided on a lower part of the entire tool and is connected to the motor housing by a grip part; and when the battery pack is mounted on the battery-mount part, the center of gravity of the entire tool is located within the bottom surface of the battery pack and within the grip part in a plan view.

In an eleventh aspect of the present teachings, the axis line of the motor housing of any of the preceding aspects is tilted such that it is oriented downward more than is a straight line that is oriented in the front-rear direction parallel to the bottom surface of the battery pack.

In a twelfth aspect of the present teachings, the maximum cross-sectional area of the battery pack of any of the preceding aspects in a horizontal direction is greater than the maximum cross-sectional area of the motor housing of any of the preceding aspects in the horizontal direction.

In a thirteenth aspect of the present teachings, an torque-adjusting ring is provided axially frontward of the motor housing of any of the preceding aspects; a chuck that chucks a bit is provided axially frontward of the torque-adjusting ring; and, downward of the torque-adjusting ring or the chuck, a light, which illuminates axially frontward of the chuck, is axially provided frontward of a front-half portion of the torque-adjusting ring.

In a fourteenth aspect of the present teachings, the outer diameter of the chuck is larger than the outer diameter of the motor.

A fifteenth aspect of the present teachings is a combination, comprising: a first power tool that can be used by mounting a first battery pack having a first rated voltage, the first power tool comprising a first motor having a stator formed of a plurality of laminated steel plates that each have a first thickness; and a second power tool that can be used by mounting a second battery pack having a second rated voltage, which differs from the first rated voltage, the second power tool comprising a second motor having a stator formed of a plurality of laminated steel plates that each have a second thickness.

A sixteenth aspect of the present teachings is a combination, comprising: a first power tool that can be used by mounting a first battery pack having a first rated voltage, the first power tool comprising a first motor having a first coil; and a second power tool that can be used by mounting a second battery pack having a second rated voltage, which differs from the first rated voltage, the second power tool comprising a second motor having a second coil, the wire diameter of which differs from that of the first coil.

According to some aspects of the present teachings, power tools are provided that excel in ease of use and can be made compact even if a battery pack having a rated voltage, e.g., of 18 V is used.

### BRIEF DESCRIPTION OF THE DRAWINGS

FIG. 1 is a side view of an impact driver according to one representative, non-limiting embodiment of the present teachings.

FIG. 2 is a front view of the impact driver of FIG. 1.

FIG. 3 is an enlarged plan view of the impact driver of FIG. 1.

FIG. 4 is a center longitudinal-cross-sectional view of the impact driver of FIG. 1.

FIG. 5 is an enlarged cross-sectional view taken along line A-A in FIG. 1.

FIG. 6 is an enlarged view of a screw-boss portion on an upper side of a brushless motor.

FIG. 7 is an explanatory diagram in which the impact driver of FIG. 1 is lying on its side substantially horizontally on a flat surface.

FIG. 8A and FIG. 8B provide explanatory diagrams that compare the maximum cross-sectional areas of a main-body part and a battery pack, wherein FIG. 8A shows the maximum cross section of the main-body part and FIG. 8B shows the maximum cross section of the battery pack.

FIG. 9 is a side view of the impact driver of FIG. 1, in which a battery pack having a different rated capacity is mounted.

FIG. 10 is a side view of the impact driver of FIG. 1 having a modified display.

FIG. 11 is a front view (a partial cross section) of the impact driver of FIG. 10.

FIG. 12 is a side view of an impact driver having a modified main-body part according to another representative, non-limiting embodiment of the present teachings.

FIG. 13 is a front view of the impact driver of FIG. 12.

FIG. 14 is a center longitudinal-cross-sectional view of an impact driver having another modified main-body part that has been tilted according to another representative, non-limiting embodiment of the present teachings.

FIG. 15 is a front view of the impact driver of FIG. 14.

FIG. 16 is a center longitudinal-cross-sectional view of a driver drill according to another representative, non-limiting embodiment of the present teachings.

FIG. 17 is a front view of the driver drill of FIG. 16.

FIG. 18 is an explanatory diagram of a system according to the present teachings in which different battery packs are used for different purposes with a shared DC tool.

FIG. 19 is an explanatory diagram of another system according to the present teachings in which different DC tools are used for different tasks with a shared battery pack.

FIG. 20 is an explanatory diagram of a set according to the present teachings that includes two types of DC tools and battery packs.

### DETAILED DESCRIPTION OF EMBODIMENTS ACCORDING TO THE PRESENT TEACHINGS

Representative, non-limiting embodiments of the present teachings are explained below with reference to the drawings.

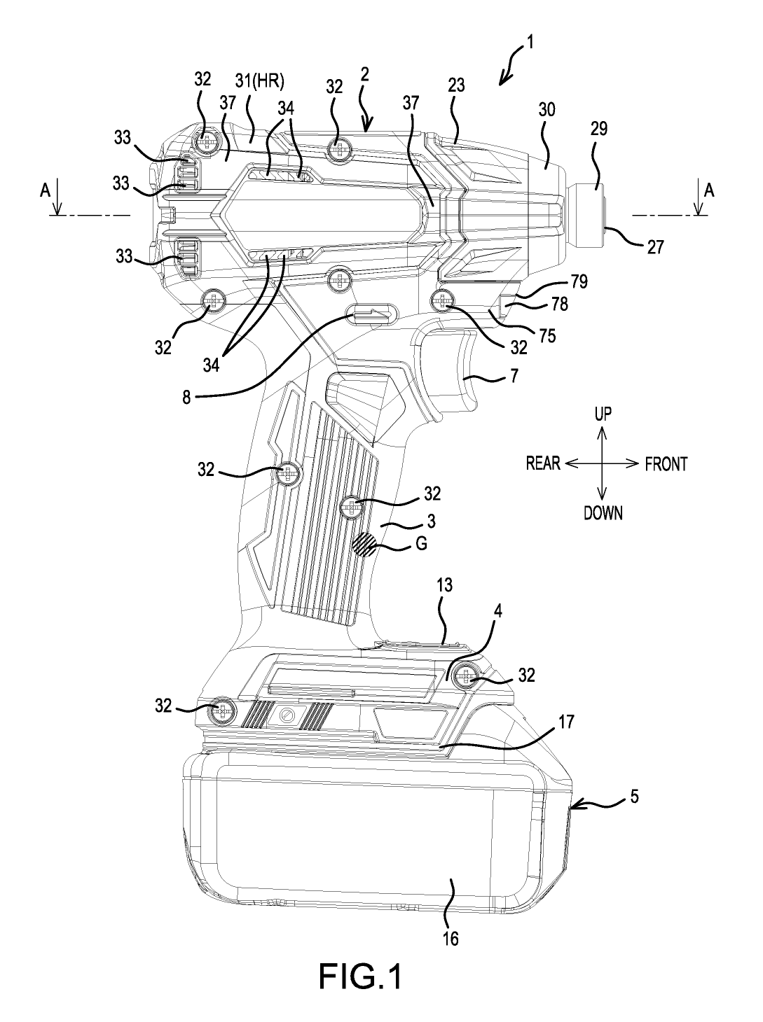

Referring to FIGS. 1-5, an impact driver 1 according to a first embodiment of the present teachings generally comprises a main-body part 2, in which its central axis is defined as a front-rear direction (axial direction), and a grip part 3 that projects (extends) downward from the main-body part 2. A battery pack 5 serves as the power supply for the impact driver 1 and is mounted on a battery-mount part 4, which is provided on a lower end of the grip part 3. A switch 6, from which a trigger 7 protrudes frontward, is housed in an upper part of the grip part 3, and a forward/reverse-switching lever (reversing switch lever) 8 of a motor is provided on an upper side of the switch 6. A terminal block 9, which comprises a terminal plate 10, and a controller 11, which comprises a control circuit board 12 having a microcontroller (microprocessor), a switching device, etc., installed thereon, are provided on the battery-mount part 4. In addition, a switch panel 13 is provided on an upper surface of the battery-mount part 4. The switch panel 13 comprises a button switch 14 for switching (changing) the torque, the impact force, or the like output by the impact driver 1, and a display 15, which displays the current torque, impact force, or the like, as well as the remaining charge level of the battery pack 5.

In the battery pack 5, not-shown terminals are electrically connected with the terminal plate 10 of the terminal block 9 and are provided on an upper surface of a box-shaped case 16, which houses a plurality of battery cells (e.g., lithium-ion battery cells). A pair of rails 18, 18 is provided on the left and right sides of the battery pack 5 and respectively mate (engage) with rail guides 17, 17 provided on the left and right sides of the battery-mount part 4. A hook 19 protrudes from the upper surface of the battery pack 5 and is biased upward from the case 16. The hook 19 detachably engages and locks in a recess 20 provided on a front-side lower surface of the battery-mount part 4. The battery pack 5 can be removed by pressing a button 21, which is provided on a front surface of the case 16, into the case 16. The battery pack 5 may have a rated voltage, e.g., of 18 V.

In order from the rear of the impact driver 1, a brushless motor 22 and a hammer case 23 are housed in the main-body part 2. The interior of the hammer case 23 contains: a planetary-gear, speed-reducing mechanism 24, which reduces the rotational speed of a rotary shaft 46 of the brushless motor 22; a spindle 25, which is rotated at a reduced speed by the planetary-gear, speed-reducing mechanism 24; an impact mechanism (hammer) 26, which applies an impact force (hammering or impulse) to the rotation of the spindle 25; and an anvil 27, which constitutes the last output shaft and protrudes frontward from a front end of the main-body part 2. The hammer case 23, which includes the anvil 27, constitutes one representative, non-limiting example of an output part according to the present teachings. An insertion hole 28, which is configured to hold (receive) a bit (tool bit), and a sleeve (bit sleeve) 29, which is configured for attaching and detaching (holding) the bit, are provided at the tip of the anvil 27. Axially rearward of the sleeve 29, a rubber bumper 30 is mounted on an external surface of a front part of the hammer case 23.

A rear-half portion of the main-body part 2 comprises a substantially tube-shaped motor housing 31, which houses the brushless motor 22 and is integral with the grip part 3. It is noted that the motor housing 31 and the grip part 3 are formed by joining together, using a plurality of screws 32, a pair of left and right housing halves HR, HL, which respectively integrally form the motor housing halves and the grip part halves. The rear end of the motor housing 31 is closed up and has air-exhaust ports 33 formed therein. Air-suction ports 34 are formed, axially frontward of the air-exhaust ports 33, on the side surfaces of the motor housing 31.

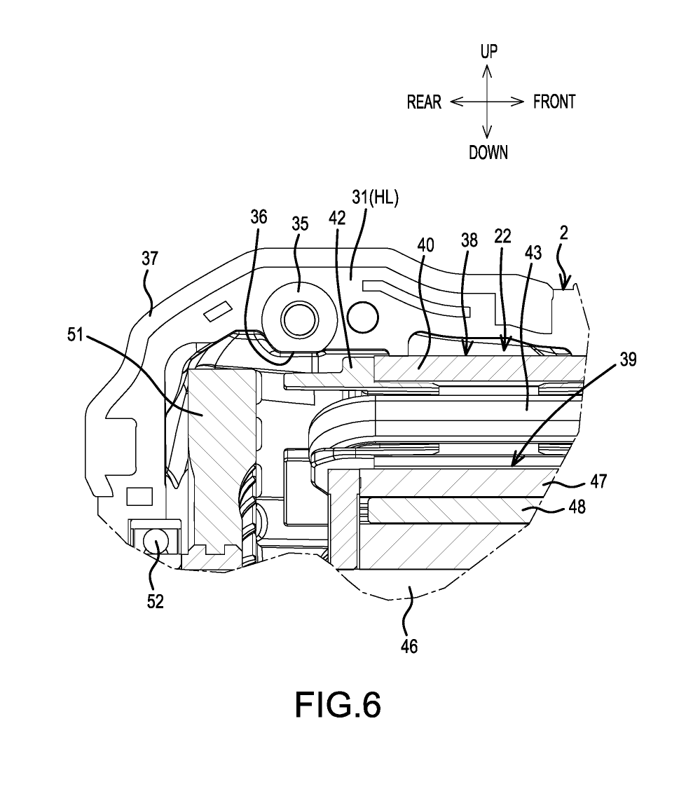

As shown in FIG. 6, in the housing halves HR, HL, one of the screw bosses 35 for screw fastening the housing halves HR, HL together has a bevel 36 formed on a lower surface of the screw boss 35 and upward of the brushless motor 22. The bevel 36 makes it possible to arrange an upper side of the motor housing 31 closer to the brushless motor 22, thereby reducing the overall height of the impact driver 1. Furthermore, integrally-formed elastomers (elastomeric coverings or skins) 37 are disposed on, and thus protect, portions of the surfaces of the housing halves HR, HL, in particular portions of the side surfaces of the motor housing 31, of the side surfaces of the grip part 3, and of the side surfaces of the battery-mount part 4.

The brushless motor 22 is an inner-rotor-type motor that comprises a stator 38 and a rotor 39. The stator 38 comprises a stator core 40, which is formed by laminating a plurality of steel plates (sheets). A front-insulating member 41 and a rear-insulating member 42 are provided on the front and rear of the stator core 40, respectively. Two or more coils 43 are wound around the stator core 40 via the front-insulating member 41 and the rear-insulating member 42. A sensor circuit board 44 is attached to the front-insulating member 41 and has rotation-detection devices 45 installed on a rear surface thereof.

The outer diameter of the stator 38 is 38 mm, which is the same as that of a brushless motor for a power tool that is utilized (operated) with a rated voltage of 10.8 V. However, to support the higher rated voltage of 18 V, the wire diameter of the coils 43 is reduced and the number of windings of the coils 43 is increased. By reducing the outer diameter of the stator 38 and by using the bevel shape on the screw boss 35, the maximum outer diameter of the motor housing 31, which includes the elastomers 37, can be kept to 55 mm or less.

The rotor 39 comprises a rotary shaft 46, which is located at the axial center of the rotor 39. A tube-shaped rotor core 47 is disposed around the rotary shaft 46. Permanent magnets 48 are held within the rotor core 47. A pinion 49 is attached to the front end of the rotary shaft 46, and a bearing 50 is mounted rearward of the pinion 49. A centrifugal fan 51 is attached to the rear end of the rotary shaft 46 inward of (adjacent to) the air-exhaust ports 33. A bearing 52 is mounted rearward of the fan 51 and is held by a rearward inner surface of the motor housing 31. The front end of the rotary shaft 46 is inserted through a bearing retainer 53, which is held by the motor housing 31 axially frontward of the brushless motor 22, and protrudes axially frontward from the bearing retainer 53. The bearing 50 is held by the bearing retainer 53 and rotatably supports the rotary shaft 46.

The bearing retainer 53 has a disc shape and is made of metal. A latching rib 54 is provided on (extends radially inwardly from) an inner surface of the motor housing 31 and latches (engages) in a circumferential groove (constricted part) formed in the center (along its axial direction) of the circumferential surface of the bearing retainer 53 such that the bearing retainer 53 is held by the motor housing 31 in the state in which movement of the bearing retainer 53 in the front-rear direction is restricted (blocked). The front peripheral edge portion of the bearing retainer 53 includes a ring wall (circumferential or cylindrical wall) 55 that projects axially frontward from a base of the bearing retainer 53. A male thread is formed on the outer circumferential surface of the ring wall 55. The ring wall 55 is screwed into the rear end portion of the hammer case 23, thereby closing up the rear portion of the hammer case 23. The hammer case 23 is a tubular body that is made of metal, and the front-half portion of the hammer case 23 is tapered towards the front of the impact driver 1. A front-tube part 56 is formed at the front end of the hammer case 23 and is engaged with the inner surface of the motor housing 31 so as to prevent rotation of the hammer case 23 relative to the motor housing 31.

Furthermore, the rear end of the spindle 25 is axially supported by a bearing 57 that is seated in the front part of the bearing retainer 53. A rear part of the spindle 25 includes a hollow, disc-shaped carrier part 58, and the pinion 49 of the rotary shaft 46 protrudes into a bottomed hole 59, which is formed in the axial center and on the rear surface of the spindle 25.

The planetary-gear, speed-reducing mechanism 24 comprises an internal gear 60, which has internal teeth, and three planetary gears 61, which have external teeth that mesh with the internal gear 60. The internal gear 60 has a large-diameter part 62 on an outer-circumference side of a front part. The large-diameter part 62 engages with an inner-circumferential surface of the hammer case 23 and thereby is rotationally locked. Movement of the internal gear 60 in the axial direction is restricted between the ring wall 55 and a step 63 formed on an inner circumferential surface of the hammer case 23. Each of the planetary gears 61 is rotationally supported inside the carrier part 58 by a respective pin 64 and all of the planetary gears 61 mesh with the pinion 49.

The impact mechanism 26 comprises a hammer 65, which is mounted externally of the spindle 25, and a coil spring 66, which biases (urges) the hammer 65 frontward. The hammer 65 comprises a pair of tabs (dog teeth) 67, 67 extending frontward from its front surface. The hammer 65 is connected to the spindle 25 via balls 68, 68 that are fitted in and straddle an outer-side cam groove formed on an inner surface of the hammer 65 and an inner-side cam groove formed on the surface of the spindle 25. In addition, a ring-shaped groove 69 is formed on a rear surface of the hammer 65, and a front end of the coil spring 66 is inserted therein. A rear end of the coil spring 66 is received (held) by a front surface of the carrier part 58.

The anvil 27 is axially supported by a bearing 70, which is held by the front-tube part 56 of the hammer case 23. Arms 71, 71 respectively mate (engage) with the tabs 67, 67 of the hammer 65 in the rotational direction and are formed on the rear end of the anvil 27. A projection 72 projects from the rear surface of the bearing 70 and approaches the arms 71 beyond the rear surface of the front-tube part 56. A washer 73, which is made of resin and receives the arms 71, mates with an outer side of the projection 72. In addition, a mating hole 74 is formed in the front surface of the spindle 25 at its axial center, and the rear end of the anvil 27 is coaxially inserted therein.

An extension part 75, which extends from the housing halves HR, HL and partially covers a lower surface of the hammer case 23, is formed downward of the hammer case 23 between the hammer case 23 and the trigger 7. An LED board 76, which comprises an LED 77, is housed in the extension part 75 at an attitude such that the LED 77 is oriented diagonally upward. A lens 78 is provided frontward of the LED 77 and is exposed via a window 79, which is provided on a front surface of the extension part 75. Thus, when the LED 77 is turned ON, light from the LED 77 radiates frontward of the anvil 27 via the lens 78.

In the impact driver 1 configured as described above, when the battery pack 5 is slid from the front of the battery-mount part 4 with the rails 18 mated (engaged) with the rail guides 17, 17, the terminals on the upper surface of the battery pack 5 are electrically connected to the terminal plate 10 provided on the terminal block 9, and the hook 19 engages with the recess 20, thereby mounting the battery pack 5 in a locked state.

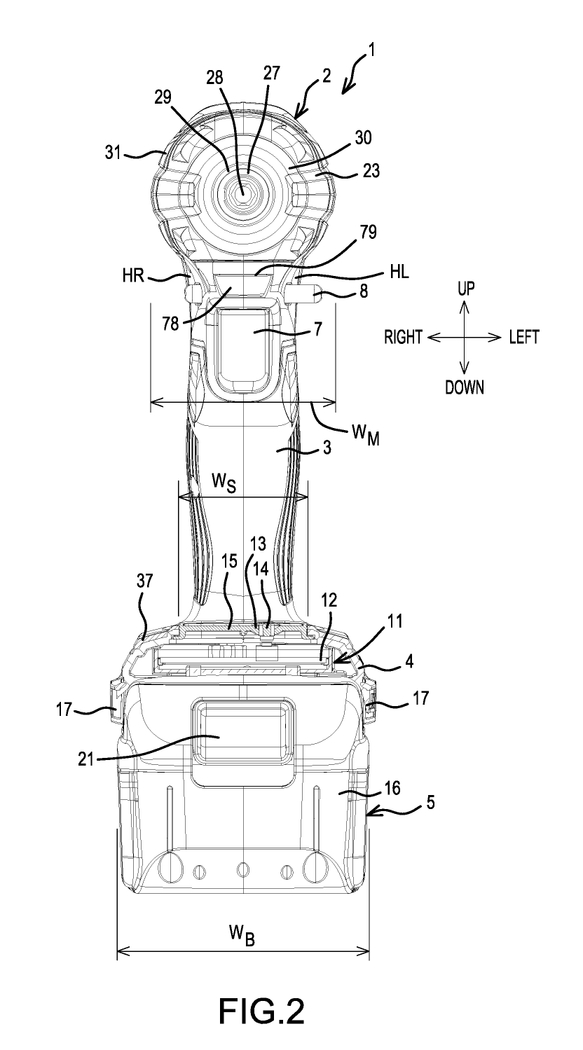

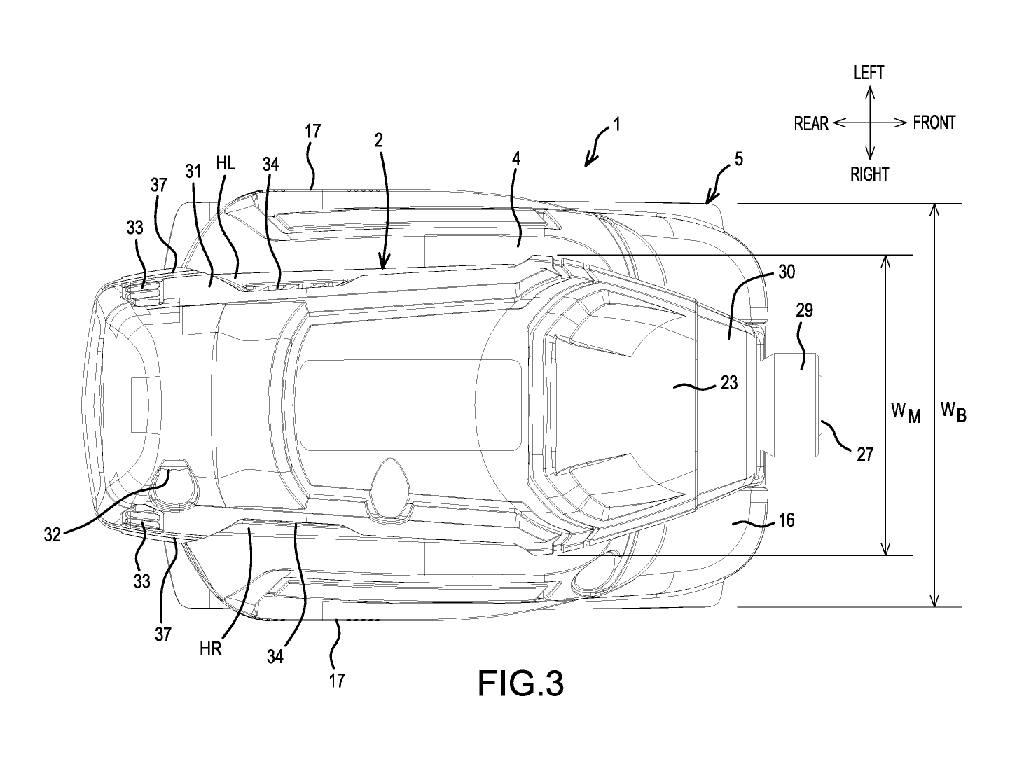

In this mounted and locked state, both lateral sides of the battery pack 5, the left-right width of which is larger than that of the motor housing 31, protrude beyond both lateral sides of the motor housing 31 in a plan view as shown in FIGS. 2 and 3. In the present embodiment, the ratio of the maximum width W_{M} of the motor housing 31, which includes the elastomers 37, with respect to the maximum width W_{B} of the battery pack 5, i.e. W_{M}/W_{B}, is approximately 0.73.

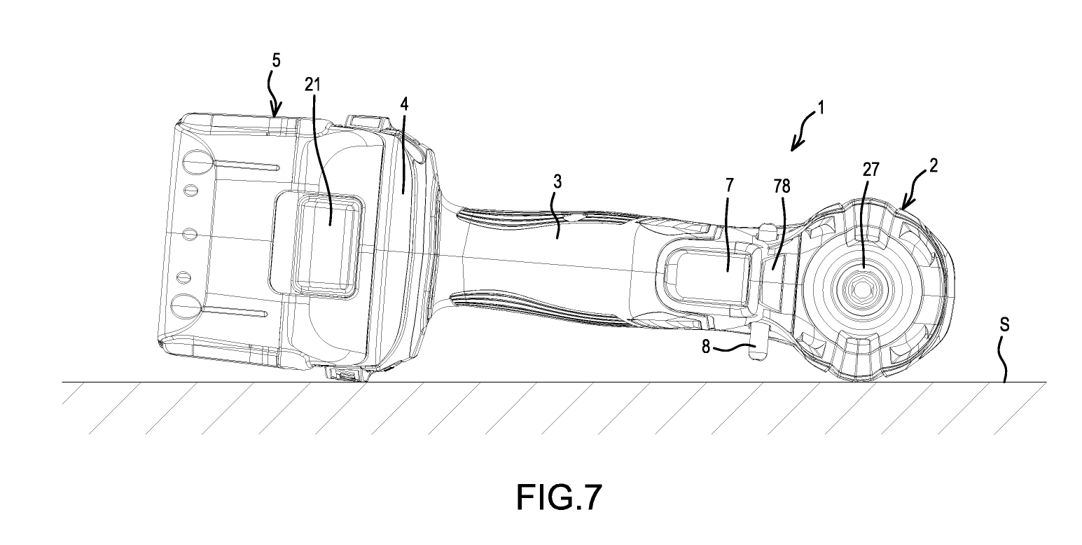

Thus, because the maximum width W_{B} of the battery pack 5 is relatively large, when the impact driver 1 is placed on a flat surface (ground plane) S in a horizontal orientation, as shown in FIG. 7, the forward/reverse-switching lever 8 does not make contact with the ground plane S even if the forward/reverse-switching lever 8 has been switched such that it projects toward the side of the ground plane S. That is, it is possible to prevent an inadvertent switching of the forward/reverse-switching lever 8 in such a circumstance, because the maximum-slide position of the forward/reverse-switching lever 8 does not reach the ground plane S when the impact driver 1 is placed horizontally on the ground plane S.

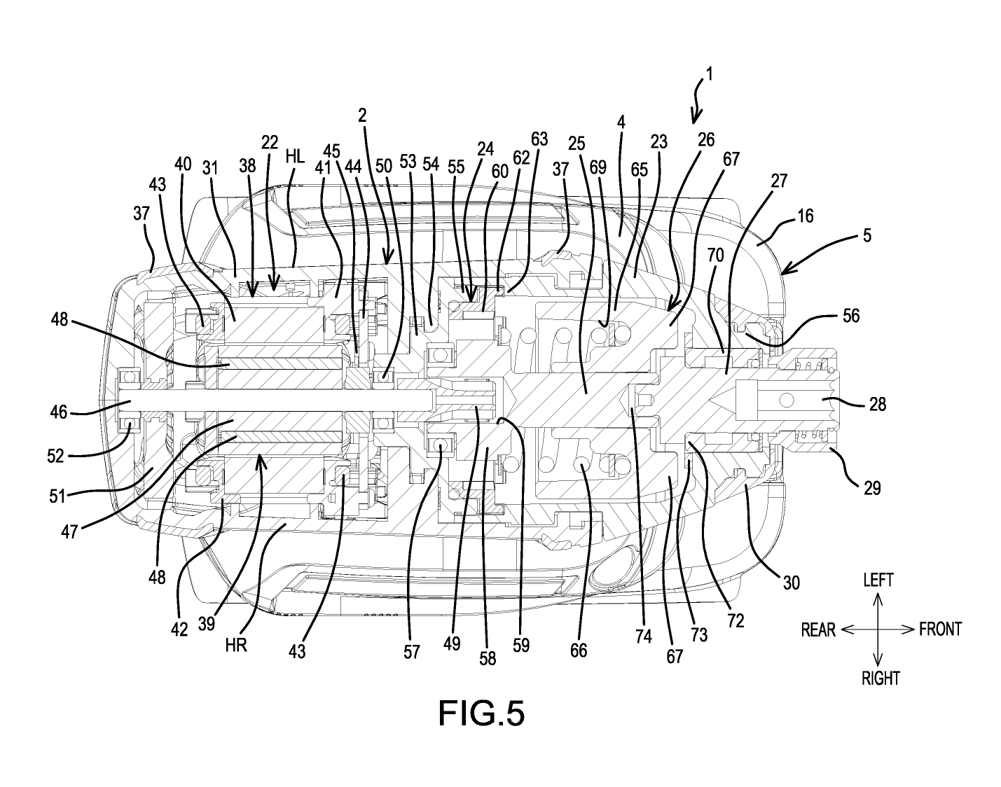

In addition, as shown in FIG. 2, the transverse width W_{S} of the switch panel 13 is smaller (less) than the maximum width W_{M} of the motor housing 31 located directly thereabove. Thus, by making the left-right width of the switch panel 13 smaller (less) than the left-right width of the motor housing 31, objects (or obstacles located on the upper side when the impact driver 1 is lifted upward) falling from above tend not to hit the motor housing 31 of the main-body part 2 or hit the switch panel 13, the display 15, or the like. In particular, as shown in FIGS. 3 and 5, because the display 15 is disposed within the maximum width W_{M} of the motor housing 31 in a plan view and therefore is not visible from directly above, the display 15 likewise is effectively protected from falling objects.

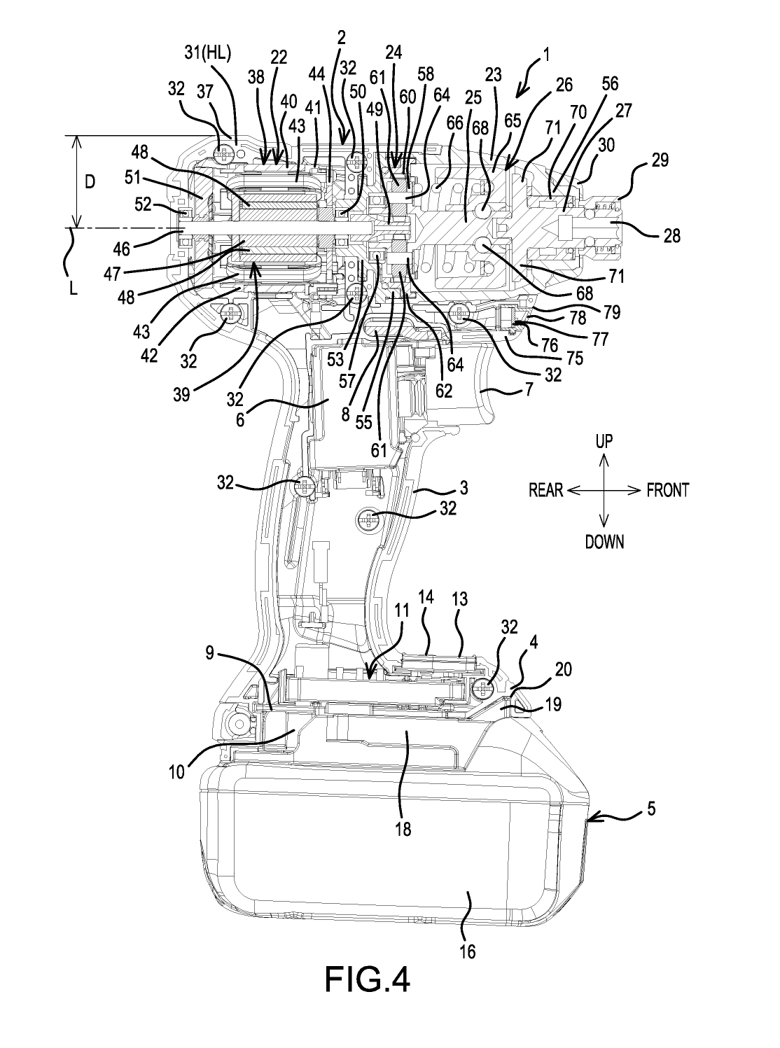

Furthermore, the distance D from the axis line L (axis line of the motor housing 31) of the rotary shaft 46 of the brushless motor 22 shown in FIG. 4 to the maximum-height position of the main-body part 2, which includes the elastomers 37, is 27 mm.

Furthermore, the center of gravity of the entire impact driver 1 is located within circle mark G shown in FIG. 1. In a plan view, this center-of-gravity position is located within the area of the bottom surface of the battery pack 5 and within the grip part 3.

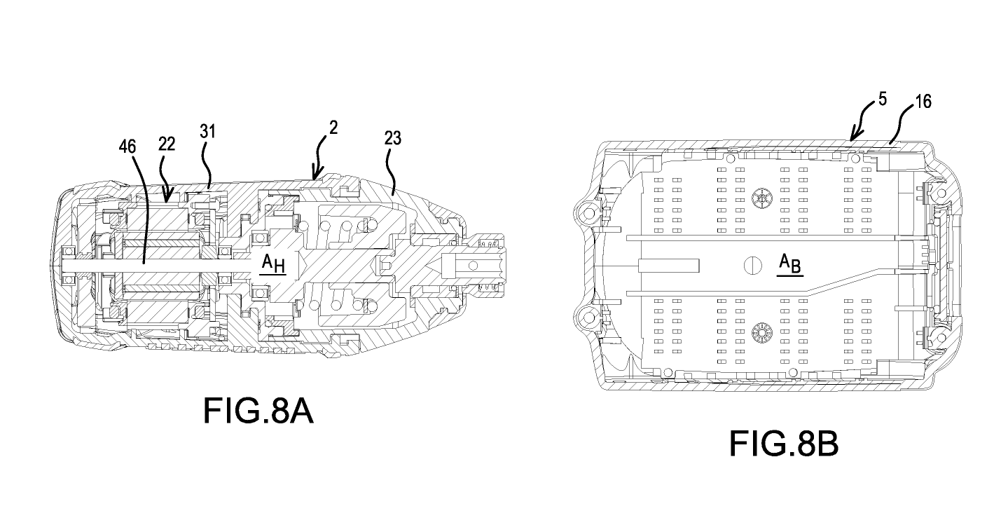

In addition, as shown in FIG. 8, the maximum cross-sectional area A_{B} (FIG. 8B) of the battery pack 5 in a horizontal section is larger than the maximum cross-sectional area A_{H} (FIG. 8A) of the main-body part 2 (here, the horizontal cross-sectional area through which the axis line L of the rotary shaft 46 passes), which includes the motor housing 31, likewise in a horizontal section.

In the above-described impact driver 1, when the trigger 7 is pressed in and the switch 6 is turned ON, power (current) is supplied to the brushless motor 22 and the rotary shaft 46 rotates. That is, the control circuit board 12 of the controller 11 acquires the rotational state of the rotor 39 by obtaining rotation-detection signals, which indicate the positions of the permanent magnets 48 of the rotor 39 output from the rotation-detection devices 45 of the sensor circuit board 44, and controls the ON/OFF state of each of the switching devices in accordance with the acquired rotational state. Consequently, the rotor 39 is rotated, together with the rotary shaft 46, by sequential supplying electric current to each of the coils 43 of the stator 38.

Thereupon, the planetary gears 61, which mesh with the pinion 49, revolve inside the internal gear 60 and cause the spindle 25 to rotate at a reduced speed via the carrier part 58. As a result, the hammer 65 also rotates, the anvil 27 is caused to rotate via the arms 71, which the tabs 67 engage, and screw tightening using the bit is thereby enabled. As the screw tightening progresses and the torque of the anvil 27 increases, the hammer 65 retracts against the biasing force of the coil spring 66 while the balls 68 roll along the inner-side cam groove of the spindle 25. When the tabs 67 separate from the arms 71, the hammer 65 rotates while advancing owing to the biasing force of the coil spring 66 and the guiding of the inner-side cam groove. As a result, the tabs 67 once again engage with (strike) the arms 71, and a rotational impact force (an impact) is generated by the anvil 27. This repetitive striking makes it possible to increase the torque and further tighten the screw, bolt, etc.

Meanwhile, when the centrifugal fan 51 rotates together with the rotation of the rotary shaft 46, air is drawn in through the air-suction ports 34 on the front side, passes through and cools the brushless motor 22, and is then discharged through the air-exhaust ports 33 on the rear side.

Thus, because the impact driver 1 of the above embodiment has a ratio of the maximum width W_{M} of the motor housing 31 to the maximum width W_{B} of the battery pack 5 of 0.73, even when a battery pack 5 having a rated voltage of 18 V is used, it is possible to make the impact driver 1 compact while still excelling in ease of use.

However, the ratio of W_{M}/W_{B} is not limited to 0.73. For example, it is possible to make the impact driver 1 compact and prevent inadvertent switching of the forward/reverse-switching lever 8 with a ratio W_{M}/W_{B} of up to approximately 0.75, and consequently the ratio W_{M}/W_{B} is preferably less than 0.75.

Similarly, because the outer diameter of the stator 38 of the brushless motor 22 is set to 38 mm and the outer diameter of the motor housing 31 is set to 55 mm, even when a battery pack 5 having a rated voltage of 18 V is used, the motor housing 31 can be made compact in the radial direction and ease of use is excellent.

However, the outer diameter of the stator 38 is not limited to 38 mm. For example, as long as the outer diameter is 40 mm or less, the motor housing 31 can be made compact, and consequently the outer diameter of the stator 38 may be set to 40 mm or less.

In addition, because the motor housing 31 has a substantially tube shape, in which its axis line L extends in the front-rear direction, and the distance D from the axis line L to the maximum-height position of the motor housing 31 is set to 27 mm, even if a battery pack 5 having a rated voltage of 18 V is used, the motor housing 31 can be made compact in the height direction, and it becomes easy to use even in a confined work location.

However, the smaller the distance D, the greater the compactness, and consequently it is also possible to reduce the distance D to a value smaller (less) than 27 mm if the wall thickness of the motor housing 31 can be made thinner, or the like.

Here in particular, on the upper side of the motor housing 31, the bevel part 36 is formed on the lower surface of the screw boss 35 to join the housing halves HR, HL together, and therefore the distance D can be shortened easily. The distance D can be shortened also by enlarging the bevel part 36, locating the screw boss 35 closer to the upper side of the brushless motor 22, or the like.

Furthermore, when the battery pack 5 is mounted on the impact driver 1, the center of gravity of the entire tool is located within the bottom surface of the battery pack 5 and within the grip part 3 in a plan view, and therefore the tool has a structure in which the tool is well balanced and tends not to tip over.

In addition, because the maximum cross-sectional area A_{B} of the battery pack 5 in the horizontal direction is larger than the maximum cross-sectional area A_{H} of the main body 2, which includes the motor housing 31, in the horizontal direction, the center of gravity of the entire tool is located on the lower side, the entire tool is stable, and the sense of balance is also favorable when the grip part 3 is gripped.

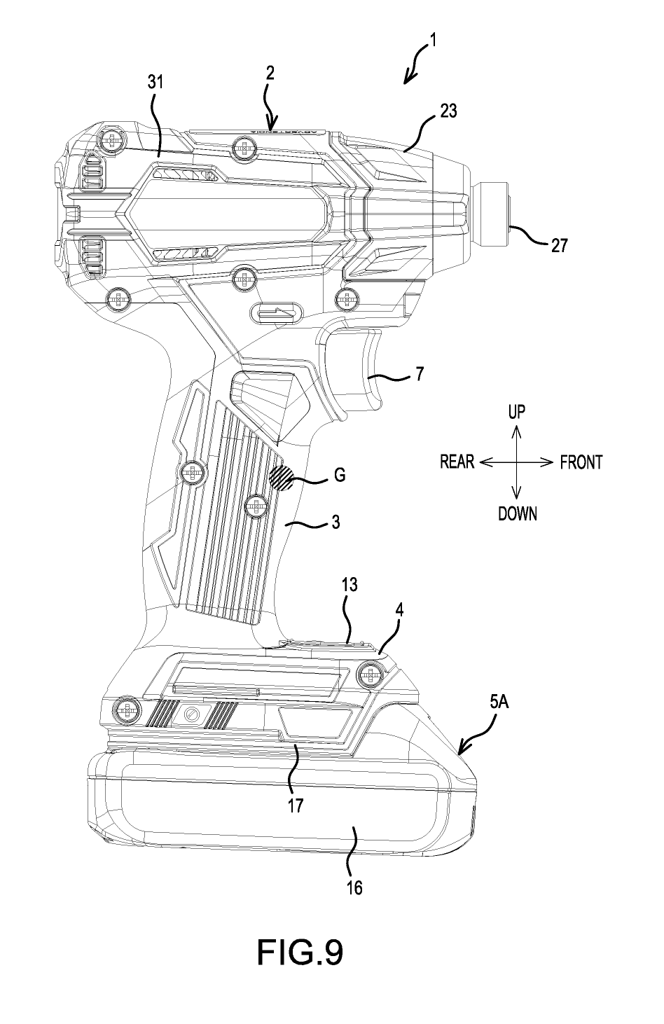

It is noted that, as shown in FIG. 9, a battery pack 5A having the same rated voltage but a lower rated capacity (i.e. fewer battery cells) can be used, in which case the overall up-down (vertical) height of the impact driver 1 becomes smaller (less). However, because the maximum width, the maximum cross-sectional area, and the like are (remain) unchanged, the relationship between the maximum width W_{M} of the motor housing 31 and the maximum width W_{B} of the battery pack 5A, the relationship between the maximum cross-sectional area A_{H} of the main-body part 2 and the maximum cross-sectional area A_{B} of the battery pack 5A, and the distance D between the axis line L and the maximum-height position of the main-body part 2 are the same as in the embodiment above. But, the center of gravity (circle mark G) is located slightly higher in the embodiment of FIG. 9 than in the embodiment of FIG. 1.

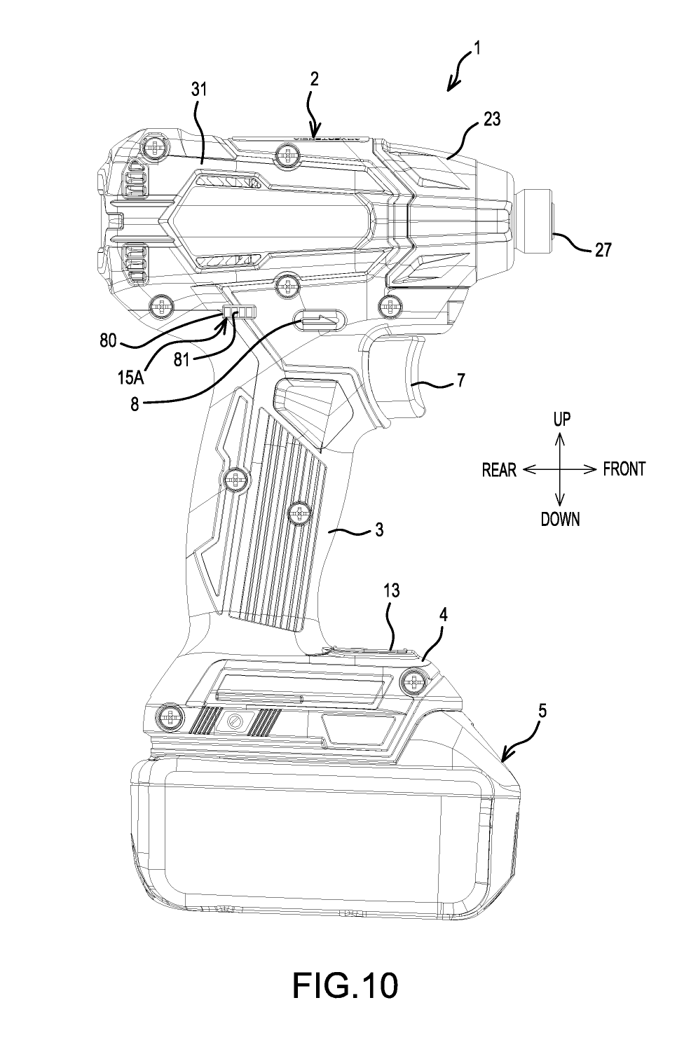

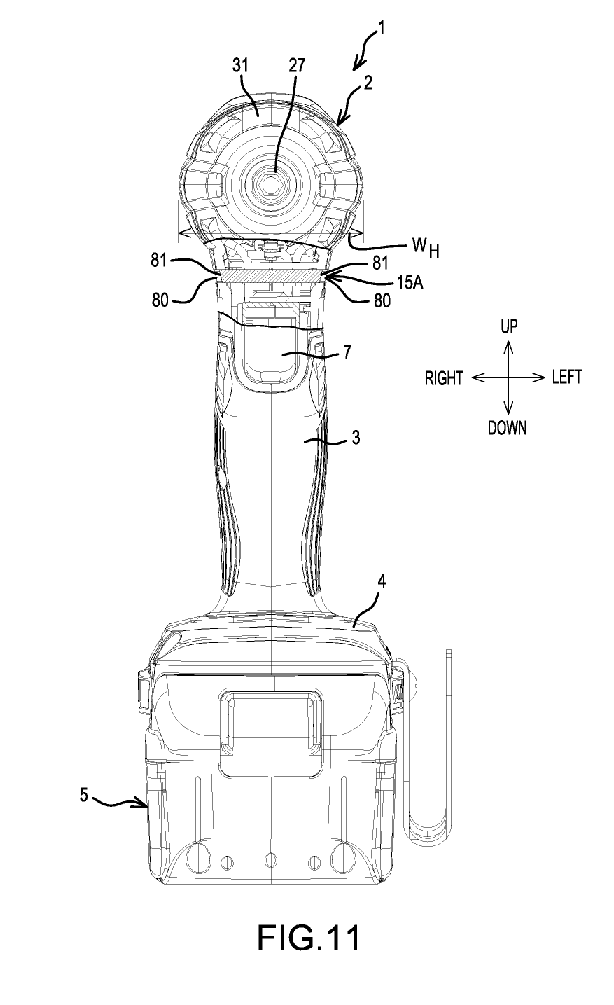

In addition, the display for indicating the remaining battery charge level is not limited to an embodiment in which the display is provided on the switch panel, as in the embodiments above. Instead, the display may be provided as a separate body that is separate from the switch panel. FIGS. 10 and 11 show one example thereof, in which a display 15A is housed (disposed) in the left-right direction in a lower part of the motor housing 31, rearward of the forward/reverse-switching lever 8. Lights 81, which are aligned in the front-rear direction and constitute a scale with four gradations, are provided on both ends in the left-right direction. The two sets of lights 81 are exposed via left and right front windows 80, respectively, provided on the motor housing 31, and the remaining battery charge level is displayed based on the number of lights 81 of the scale that are turned ON. In this embodiment as well, the transverse width of the display 15A fits within the maximum width W_{H} of the motor housing 31.

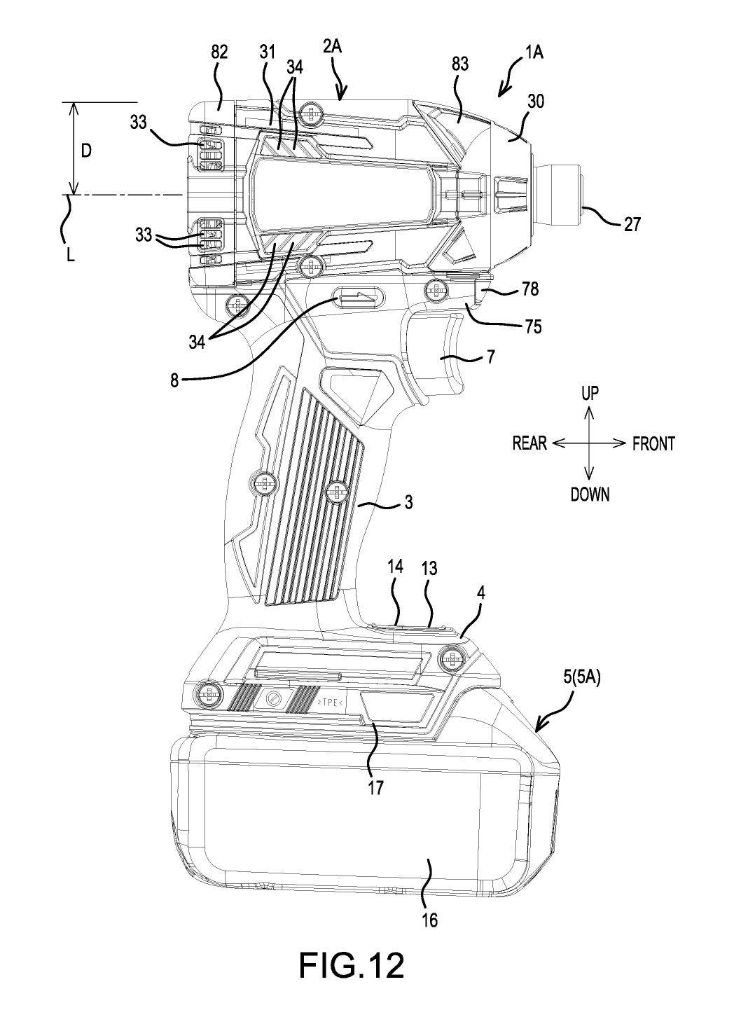

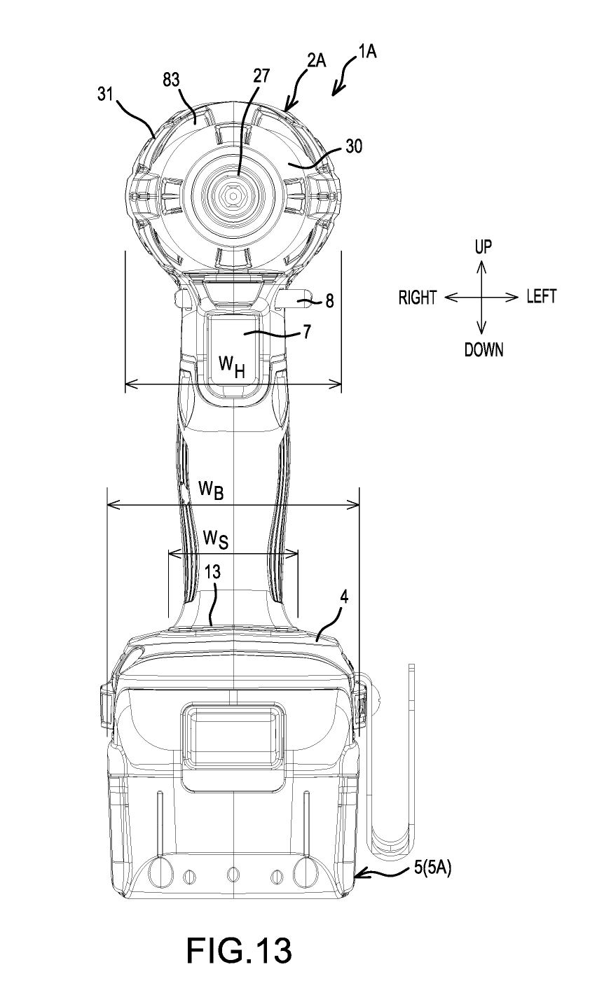

Furthermore, as shown in FIGS. 12 and 13, in an impact driver 1A comprising a main-body part 2A, the length of which is relatively short in the front-rear direction, it is likewise possible to use the 18 V battery pack 5 (5A) with the 10.8 V brushless motor. In the main-body part 2A, the motor housing 31 is made into a tube shape that is short in the front-rear direction, the rear end thereof is closed up by a rear cover 82, which has air-exhaust ports 33, and a cover 83, which is made of resin, is provided on the outer side of the hammer case 23 between the main-body part 2A and the bumper 30. In this embodiment as well, the relationship between the maximum width W_{M} of the motor housing 31 and the maximum width W_{B} of the battery pack 5 (5A), the relationship between the maximum cross-sectional area A_{H} of the main-body part 2 and the maximum cross-sectional area A_{B} of the battery pack 5 (5A), the distance D between the axis line L and the maximum-height position of the main-body part 2, and the relationship between the transverse width W_{S} of the switch panel 13 and the maximum width W_{M} of the motor housing 31 are the same as in the embodiments above.

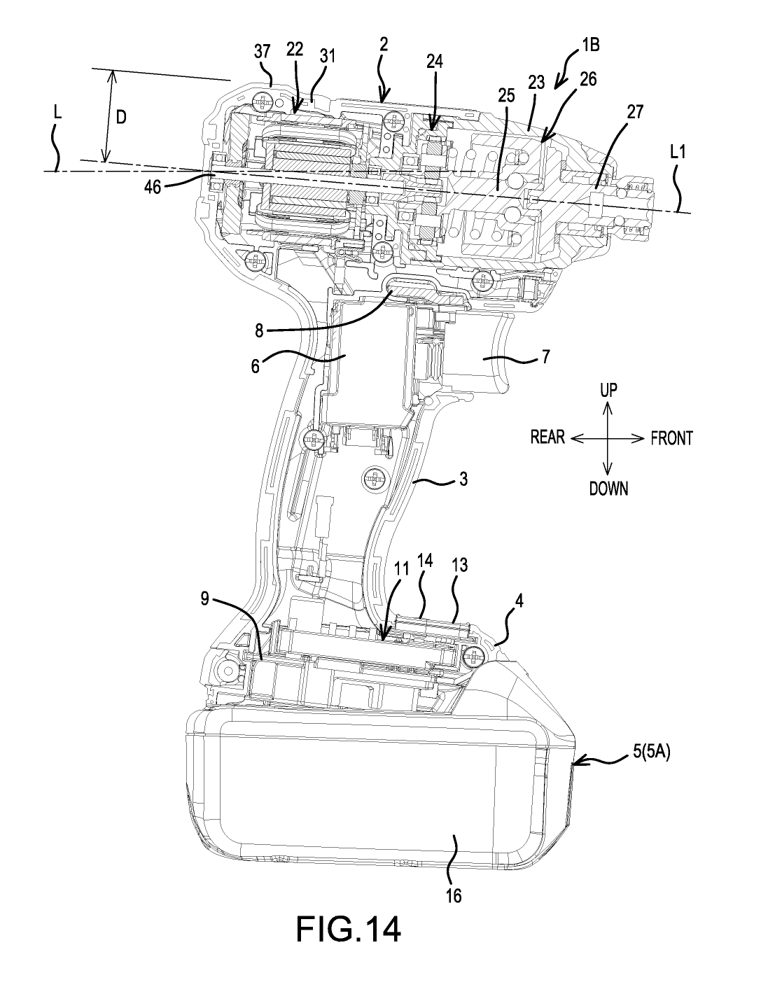

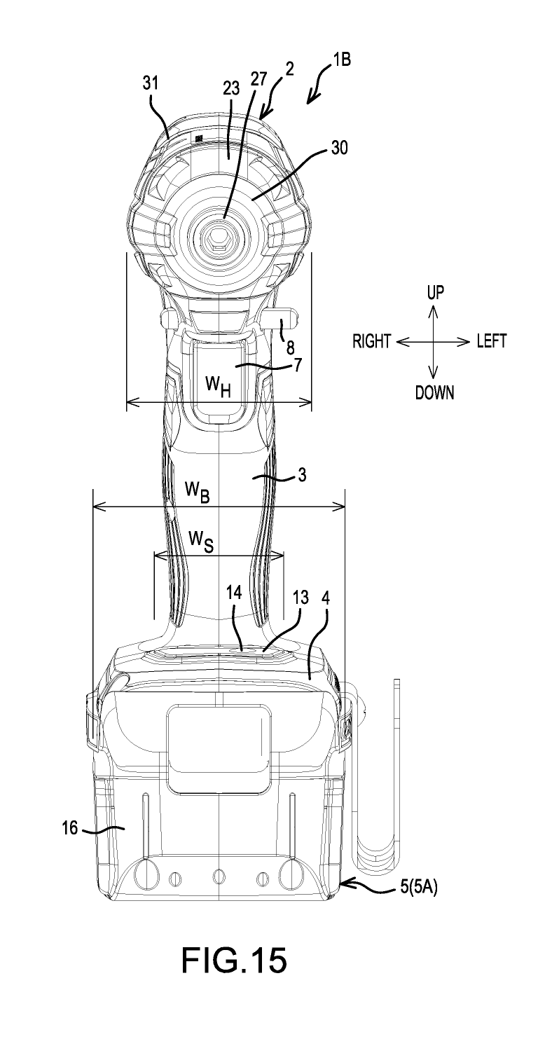

Moreover, in an impact driver 1B as shown in FIGS. 14, 15, the main-body part 2 can also be tilted such that an axis line L1 thereof is oriented downward at a prescribed angle with respect to the axis line L, which is oriented in the front-rear direction parallel to the bottom surface of the axis line L. If tilted in this manner, the force that pushes the entire tool from the grip part 3 when downward-facing work is being performed is transmitted to the bit without loss, and thereby the work can be performed comfortably. If the battery pack 5 side is heavy when the downward-facing work is being performed, a biasing force (a rotational force) that attempts to upwardly tilt the main-body part 2, with the grip part 3 serving as the center (fulcrum), comes into play. However, because the axis line L1 is tilted downward, such a tilt can be compensated for. In the embodiment of FIGS. 14 and 15 as well, the relationship between the maximum width W_{M} of the motor housing 31 and the maximum width W_{B} of the battery pack 5 (5A), the relationship between the maximum cross-sectional area A_{H} of the main-body part 2 and the maximum cross-sectional area A_{B} of the battery pack 5 (5A), the distance D between the axis line L1 and the maximum-height position of the main-body part 2, and the relationship between the transverse width W_{S} of the switch panel 13 and the maximum width W_{M} of the motor housing 31 are the same as in the embodiments above.

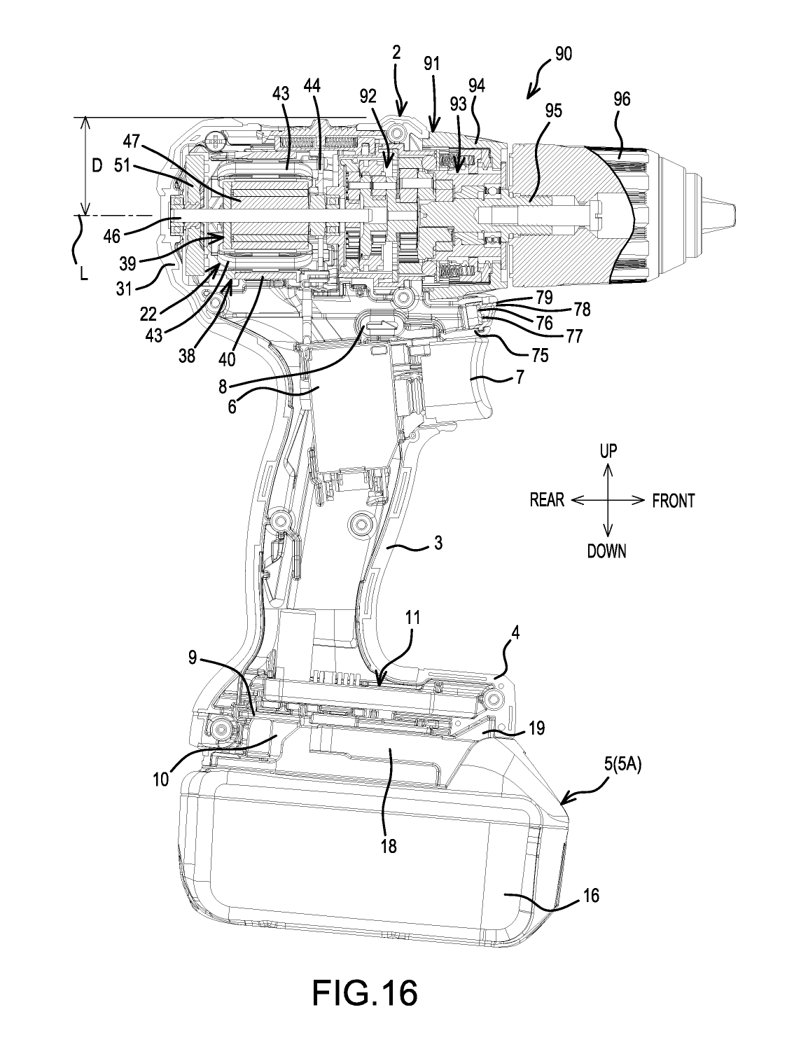

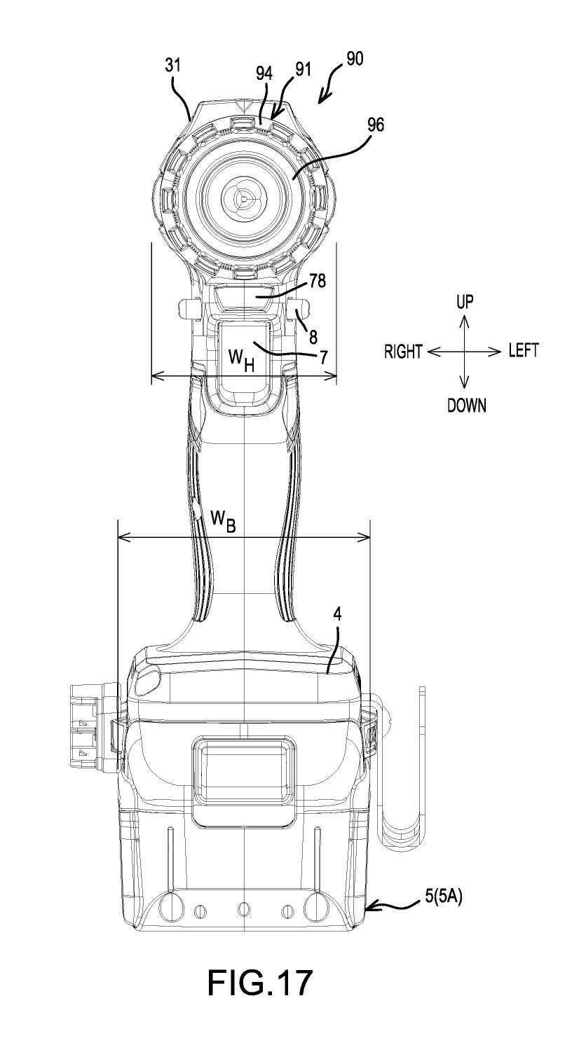

Furthermore, the present teachings are not limited to an impact driver and also can be adapted to other types of power tools. FIGS. 16 and 17 illustrate a representative, non-limiting driver drill 90; structural elements that are the same as those in the impact driver 1 are assigned the same reference symbols, and redundant explanations thereof are omitted.

In the main-body part 2 of the driver drill 90, a gear assembly 91, which comprises a speed-reducing/speed-changing mechanism 92, a clutch mechanism 93, etc., is provided axially frontward of the brushless motor 22, and a torque-adjustment ring 94, which switches between the driver mode and the drill mode in the clutch mechanism 93 and adjusts torque in the driver mode, is provided axially frontward thereof. A drill chuck 96 is provided at the tip of a spindle 95, which axially protrudes frontward from the gear assembly 91.

In such an embodiment as well, although the outer diameter of the stator 38 of the brushless motor 22 is 38 mm, which is the same as the brushless motor for a power tool having a rated voltage of 10.8 V, the coils 43 support a rated voltage of 18 V, and therefore the wire diameter is narrower and the number of windings is greater. By reducing the outer diameter of the stator 38 and by using the bevel shape of the screw boss 35, the maximum diameter of the motor housing 31 is kept to 55 mm. In addition, the outer diameter of the drill chuck 96 is larger than the outer diameter of the stator 38.

Furthermore, the axial length of the stator core 40 of this embodiment is made shorter by reducing the number of laminations of the steel plates of the stator core 40, and the grip part 3 is also located more toward the front of the main-body part 2. Due to this design, the LED 77, together with the extension part 75, is located on the front-half portion side of the lower part of the torque-adjustment ring 94 and is proximate to the rear end surface of the drill chuck 96. Thus, the LED 77 is nearer to the work location frontward of the drill chuck 96 and can thereby illuminate the work location more brightly. In addition, by locating the grip part 3 on the front side of the main-body part 2, the main-body part 2 can be stably supported and becomes easy to use.

It is noted that, in the driver drill 90 as well, the relationship between the maximum width W_{M} of the motor housing 31 and the maximum width W_{B} of the battery pack 5 (5A), the relationship between the maximum cross-sectional area A_{H} of the main-body part 2 and the maximum cross-sectional area A_{B} of the battery pack 5 (5A), and the distance D between the axis line L and the maximum-height position of the main-body part 2 are the same as in the embodiments above.

In addition, the light may be located downward of the chuck, so long as it is axially frontward of the front-half portion of the torque-adjusting ring (operation ring).

Furthermore, the present teachings are not limited to a T-type DC tool, in which the motor housing is formed (extends) in the front-rear direction and the battery pack is mounted on the lower end of the grip part, as in the impact driver, the driver drill, and the like of the embodiments above. For example, the present teachings can also be adapted (applied) to other DC tools, such as: a circular saw, in which the motor housing is formed (extends) in the left-right direction and the battery pack is mounted on the handle side; a multi-tool, a jigsaw, a hammer drill, or the like, in which the motor housing is formed (extends) in the left-right direction and the battery pack is mounted on the rear end of the motor housing; and the like. The motor likewise is not limited to a brushless motor.

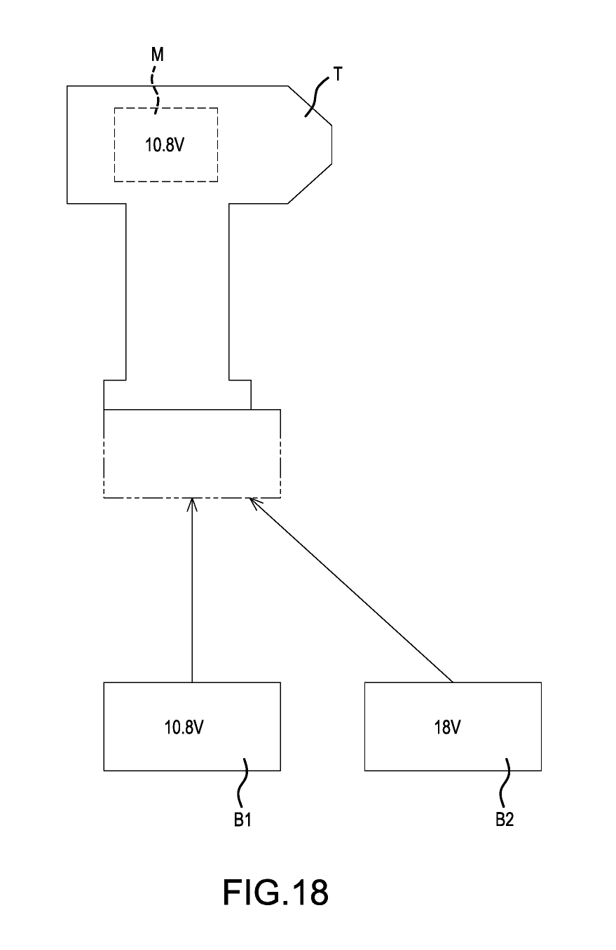

In addition, in the embodiments above, embodiments were explained in which only an 18 V battery pack is used for a DC tool having a motor for 10.8 V. However, as shown in FIG. 18, power tool systems are also conceivable in which two types of battery packs B1, B2, having differing rated voltages, are used for different purposes with a shared DC tool T. In such an embodiment, it is possible to interchangeably use the 10.8 V battery pack B1 and the 18 V battery pack B2 by, for example: interposing an adapter between the DC tool T, which has a motor M rated for 10.8 V, and the battery-mount part; by exchanging the controller, which is unitized (e.g., provided in a removable cartridge); or the like. It is also conceivable to interchangeably use three or more types of battery packs in additional embodiments of the power tool systems according to the present teachings.

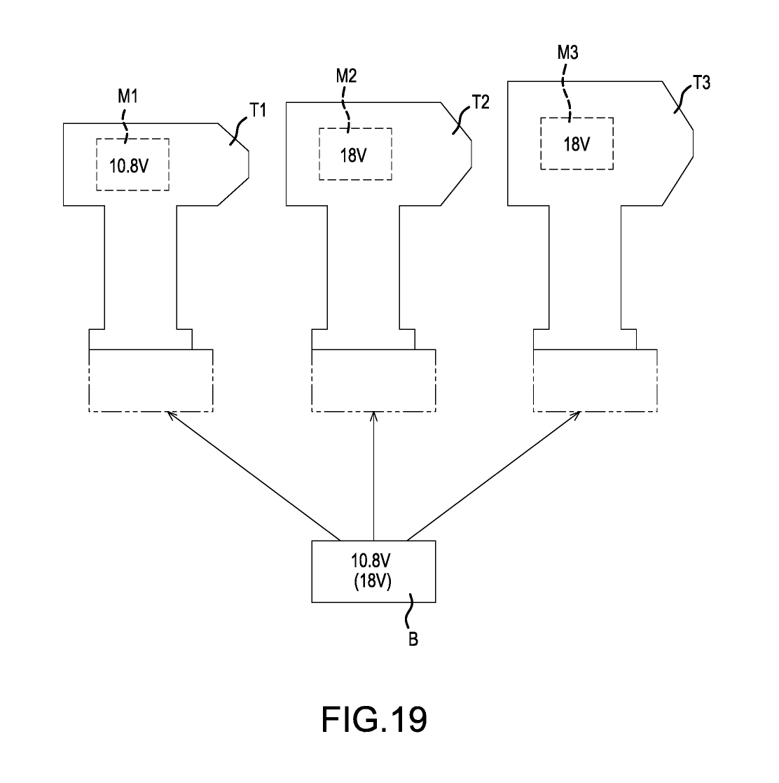

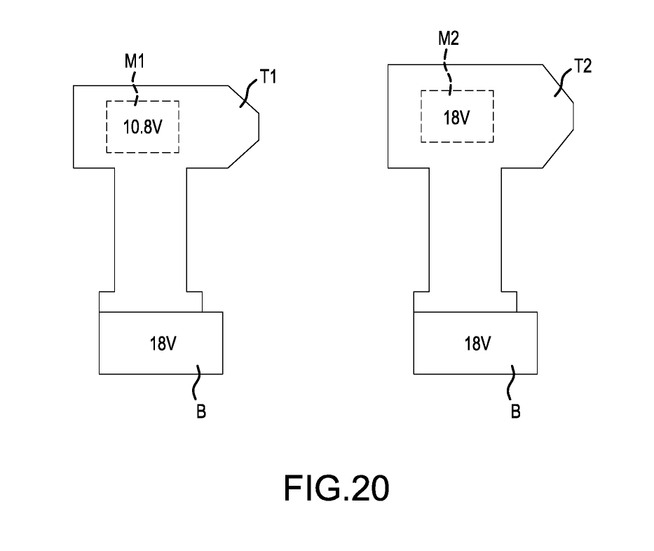

Conversely, as shown in FIG. 19, systems are also conceivable in which three types of DC tools T1-T3, having differing motors, are used for different purposes with a shared a battery pack B. In such an embodiment, it is possible to interchangeably use the DC tool T1, which has a motor M1 rated for 10.8 V, a DC tool T2, which has a motor M2 rated for 18 V and in which the stator outer diameter is small (e.g., 44 mm), and a DC tool T3, which has a motor M3 rated for 18 V and in which the stator outer diameter is large (e.g., 52 mm), with a 10.8 V or an 18 V battery pack B. It is also conceivable to interchangeably use two types or four or more types of DC tools. In the case of two types, as shown in FIG. 20, sets may be created consisting of the DC tool T1, which comprises the motor M1 rated for 10.8 V, the DC tool T2, which comprises the motor M2 rated for 18 V, and the 18 V battery packs B, B, which are used with the tools T1, T2 (there may be just one battery pack B).

In addition, when creating such DC tool sets (combinations), the rated voltage can be selected by changing the lamination thickness of the steel plates of the stator core of the stator, as was explained in the driver drill shown in FIGS. 16 and 17. That is, the following combination is also possible: a first power tool, wherein the steel plates each have a first lamination thickness and a first battery pack having a first rated voltage (e.g., 10.8 V) is mounted and available; and a second power tool, wherein the steel plates each have a second lamination thickness that differs from the first lamination thickness and a second battery pack having a second rated voltage (e.g., 18 V) is mounted and available.

Similarly, the rated voltage can be selected also by changing the wire diameter of the coils of the stator. That is, the following combination is also possible: the first power tool, wherein a first coil is used in the stator and a first battery pack having a first rated voltage (e.g., 10.8 V) is mounted and available; and a second power tool, wherein a second coil having a wire diameter different from that of the first coil is used in the stator and a second battery pack having a second rated voltage (e.g., 18 V) is mounted and available.

Furthermore, in the embodiments above, the use of motors and battery packs in the range of 10.8-18 V was described, but the voltage is not limited thereto; for example, any arbitrary voltage, such as 18-36 V, 18-54 V, 36-72 V, etc., can also be used. It is noted that 10.8 V is sometimes called 12 Vmax, and 18 V is sometimes called 20 Vmax.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings to provide improved power tools.

Moreover, combinations of features and steps disclosed in the above detailed description, as well as in the below additional examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1, 1A, 1B Impact driver
2, 2A Main-body part
3 Grip part
4 Battery-mount part
5, 5A Battery pack
8 Forward/reverse-switching lever
9 Terminal block
11 Controller
12 Control circuit board
13 Switch panel
14 Button switch
15, 15A Display
16 Case
22 Brushless motor
23 Hammer case
24 Planetary-gear, speed-reducing mechanism
25 Spindle
26 Impact mechanism
27 Anvil
31 Motor housing
35 Screw boss
36 Bevel part
38 Stator
39 Rotor
46 Rotary shaft
65 Hammer
66 Coil spring
75 Extension part
77 LED
90 Driver drill
91 Gear assembly
94 Torque-adjustment ring
95 Spindle
96 Drill chuck
HR Right-side half housing
HL Left-side half housing
S Ground plane
W_{M} Maximum width of motor housing
W_{B} Maximum width of battery pack
W_{S} Transverse width of switch panel
A_{H} Maximum cross-sectional area of main-body part
A_{B} Maximum cross-sectional area of battery pack

1. A power tool, comprising:
a motor housing that houses a motor; and
a battery-mount part to which a battery pack having a rated voltage of 18 V is mountable;
wherein the motor housing has a maximum width, the battery pack has a maximum width, and the following relationship is satisfied:
(the Maximum Width of the Motor Housing)/(the Maximum Width of the Battery Pack)<0.75.

2. The power tool according to claim 1, wherein the following relationship is satisfied:
(the Maximum Width of the Motor Housing)/(the Maximum Width of the Battery Pack)<0.73.

3. The power tool according to claim 1, wherein:
a forward/reverse-switching lever, which is configured to slide in a left-right direction that is perpendicular to an axial direction of the motor and is configured to change a rotational direction of the motor, is provided between the motor housing and the battery pack; and
a maximum-slide position of the forward/reverse-switching lever in the left-right direction is inward of a ground plane when the power tool is laid horizontally on its side on the ground plane.

4. The power tool according to claim 3, wherein:
a switch panel, which comprises a button and a display, is provided on an upper surface of the battery-mount part;
the motor housing is disposed upward of the switch panel; and
the left-right width of the switch panel is smaller than the left-right width of the motor housing.

5. The power tool according to claim 4, wherein the display is disposed within the left-right width of the motor housing in a plan view.

6. The power tool according to claim 5, wherein:
the outer diameter of the motor is 38 mm; and
the outer diameter of the motor housing is 46 mm.

7. The power tool according to claim 1, wherein:
the battery-mount part is provided on a lower part of the power tool and is connected to the motor housing by a grip part; and
when the battery pack is mounted on the battery-mount part, the center of gravity of the entire power tool is located within the bottom surface of the battery pack and within the grip part in a plan view.

8. The power tool according to claim 7, wherein an axis line of a rotary shaft of the motor is tilted downward relative to a straight line that is parallel to a bottom surface of the battery pack and intersects a rearmost portion of the rotary shaft.

9. The power tool according to claim 1, wherein:
the battery pack has a maximum cross-sectional area in a first horizontal plane that is parallel to a bottom surface of the battery pack,
the motor housing has a maximum cross-sectional area in a second horizontal plane that is parallel to a bottom surface of the battery pack, and
the maximum cross-sectional area of the battery pack in the first horizontal plane is greater than the maximum cross-sectional area of the motor housing in the second horizontal plane.

10. The power tool according to claim 1, further comprising:
a torque-adjusting ring disposed axially frontward of the motor housing;
a chuck configured to chuck a bit disposed axially frontward of the torque-adjusting ring; and,
downward of the torque-adjusting ring or the chuck, a light, which illuminates axially frontward of the chuck, disposed axially frontward of a front-half portion of the torque-adjusting ring.

11. The power tool according to claim 10, wherein the outer diameter of the chuck is larger than the outer diameter of the motor.

12. The power tool according to claim 5, wherein:
the battery-mount part is provided on a lower part of the power tool and is connected to the motor housing by a grip part;
when the battery pack is mounted on the battery-mount part, the center of gravity of the entire power tool is located within the bottom surface of the battery pack and within the grip part in a plan view;
the battery pack has a maximum cross-sectional area in a first horizontal plane that is parallel to a bottom surface of the battery pack,
the motor housing has a maximum cross-sectional area in a second horizontal plane that is parallel to a bottom surface of the battery pack, and
the maximum cross-sectional area of the battery pack in the first horizontal plane is greater than the maximum cross-sectional area of the motor housing in the second horizontal plane.

13. The power tool according to claim 12, further comprising:
a torque-adjusting ring disposed axially frontward of the motor housing;
a chuck configured to chuck a bit disposed axially frontward of the torque-adjusting ring; and,
downward of the torque-adjusting ring or the chuck, a light, which illuminates axially frontward of the chuck, disposed axially frontward of a front-half portion of the torque-adjusting ring.

14. The power tool according to claim 12, wherein the outer diameter of the chuck is larger than the outer diameter of the motor.

15. A power tool comprising:
a motor housing that houses a motor; and
a battery-mount part to which a battery pack having a rated voltage of 18 V is mountable;
wherein the outer diameter of the motor is 40 mm or less.

16. The power tool according to claim 15, wherein the outer diameter of the motor is 38 mm or less.

17. The power tool according to claim 16, wherein the outer diameter of the motor housing is 46 mm or less.

18. The power tool according to claim 17, wherein the motor housing has a maximum width, the battery pack has a maximum width, and the following relationship is satisfied:
(Maximum Width of the Motor Housing)/(Maximum Width of the Battery Pack)<0.75.

19. A power tool, comprising:
a motor housing that houses a motor; and
a battery-mount part to which a battery pack having a rated voltage of 18 V is mountable;
wherein the motor has a rated voltage of 10.8 V.
